(19) United States
(12) Patent Application Publication
(10) Pub. No.: US 2026/0065467 A1
(43) Pub. Date: Mar. 5, 2026

(54) PREDICTING THE LIKELIHOOD OF CONTRAST ENHANCED IMAGING FINDINGS FROM NON-CONTRAST IMAGING

(71) Applicant: Siemens Healthineers AG, Forchheim (DE)

(72) Inventors: Teodora Marina Chitiboi, Hamburg (DE); Andreea Bianca Popescu, Constanta (RO)

(21) Appl. No.: 18/817,291

(22) Filed: Aug. 28, 2024

(51) Int. Cl. G06T 7/00; G06V 10/26; G06V 10/764; G06V 10/77

(52) U.S. Cl. CPC G06T 7/0012; G06V 10/26; G06V 10/764; G06V 10/77; G06T 2207/10088; G06T 2207/20081; G06T 2207/20084; G06T 2207/30004; G06V 2201/03

(57) ABSTRACT

Systems and methods for determining a likelihood of contrast-enhanced imaging findings of a patient are provided. One or more non-contrast medical images of a patient are received. A likelihood of contrast-enhanced imaging findings of the patient is determined based on the one or more non-contrast medical images using a machine learning based system. The likelihood of contrast-enhanced imaging findings is output.

### TECHNICAL FIELD

The present invention relates generally to artificial intelligence/machine learning for medical imaging analysis, and in particular to an artificial intelligence/machine learning based approach for predicting the likelihood of contrast enhanced imaging findings from non-contrast medical images.

### BACKGROUND

CMR (cardiovascular magnetic resonance imaging) is a comprehensive imaging technique for non-invasively evaluating the structure and function of the cardiovascular system of a patient. LGE (late gadolinium enhancement) is a specialized technique within CMR that uses gadolinium-based contrast agents for enhancing the contrast in regions of interest during imaging. CMR LGE is the gold standard for the non-invasive assessment of myocardial scar. However, the injection of the contrast agent into the patient during the CMR exam increases the complexity, length, and cost for performing the exam, while also requiring additional patient preparation time and the presence of a clinician during the exam. Additionally, gadolinium-based contrast agents are not indicated for patients with kidney failure or allergies. During the current clinical workflow, a radiologist balances the indication for CMR LGE and the exact injection protocol with the potential side effects, the time required for the exam, and the added benefit of the resulting contrast-enhanced imaging. Reducing the need for unnecessarily performed CMR LGE exams is desirable.

### BRIEF SUMMARY OF THE INVENTION

In accordance with one or more embodiments, systems and methods for determining a likelihood of contrast-enhanced imaging findings of a patient are provided. One or more non-contrast medical images of a patient are received. A likelihood of contrast-enhanced imaging findings of the patient is determined based on the one or more non-contrast medical images using a machine learning based system. The likelihood of contrast-enhanced imaging findings is output.

In one embodiment, a plurality of medical imaging analysis tasks is simultaneously performed based on the one or more non-contrast medical images using a multi-task learning system. The plurality of medical imaging analysis tasks comprises the determining the likelihood of contrast-enhanced imaging findings and one or more supplemental tasks. The one or more supplemental tasks comprise at least one of segmentation, artifact detection, and disease detection.

In one embodiment, one or more anatomical objects are segmented from the one or more non-contrast medical images using a machine learning based segmentation network. Features are extracted from the one or more non-contrast medical images based on results of the segmentation. The likelihood of contrast-enhanced imaging findings is determined based on the extracted features using a machine learning based classification network. The features comprise at least one of features characterizing volume and geometry of the one or more anatomical objects, feature characterizing deformation of the one or more anatomical objects, quantitative statistics or texture features of the one or more anatomical objects, latent features extracted by a machine learning based feature extractor network, or radiomic features. The extracted features are supplemented with clinical parameters. The likelihood of contrast-enhanced imaging findings is determined based on the supplemented extracted features using the machine learning based classification network.

In one embodiment, the receiving, the determining, and the outputting are performed after acquisition of the one or more non-contrast medical images and before acquisition of contrast-enhanced medical images.

In one embodiment, contrast-enhanced medical images of the patient are acquired based on the likelihood of contrast-enhanced imaging findings.

In one embodiment, the one or more non-contrast medical images comprises bSSFP (balanced steady-state free precession) cine images and T1 and T2 mappings.

These and other advantages of the invention will be apparent to those of ordinary skill in the art by reference to the following detailed description and the accompanying drawings.

### BRIEF DESCRIPTION OF THE DRAWINGS

FIG. 1 shows a method for determining the likelihood of contrast-enhanced imaging findings from non-contrast images, in accordance with one or more embodiments;

FIG. 2 shows a workflow for determining a likelihood of contrast-enhanced imaging findings based on non-contrast medical images using a multi-task learning system, in accordance with one or more embodiments;

FIG. 3 shows a workflow for determining a likelihood of contrast-enhanced imaging findings based on non-contrast medical images using a multi-stage network, in accordance with one or more embodiments;

FIG. 4 shows an exemplary artificial neural network that may be used to implement one or more embodiments;

FIG. 5 shows a convolutional neural network that may be used to implement one or more embodiments;

FIG. 6 shows a schematic structure of a recurrent machine learning model that may be used to implement one or more embodiments; and

FIG. 7 shows a high-level block diagram of a computer that may be used to implement one or more embodiments.

### DETAILED DESCRIPTION

The present invention generally relates to methods and systems for predicting the likelihood of contrast-enhanced imaging findings from non-contrast medical images. Embodiments of the present invention are described herein to give a visual understanding of such methods and systems. A digital image is often composed of digital representations of one or more objects (or shapes). The digital representation of an object is often described herein in terms of identifying and manipulating the objects. Such manipulations are virtual manipulations accomplished in the memory or other circuitry/hardware of a computer system. Accordingly, is to be understood that embodiments of the present invention may be performed within a computer system using data stored within the computer system.

Embodiments described herein provide for machine learning based systems and methods for automatically predicting the likelihood of an LGE finding for a patient based on non-contrast CMR medical images. The prediction of the likelihood of an LGE finding may be performed either during the CMR exam (e.g., after the non-contrast medical images are acquired but before the contrast-enhanced medical images are acquired) or prior to the CMR exam using recently acquired non-contrast imaging of the patient. The predicted likelihood of an LGE finding may be used to generate recommendations for acquiring contrast-enhanced medical images. Advantageously, embodiments of the invention reduce the need for unnecessarily administering contrast agent and acquiring contrast-enhanced images.

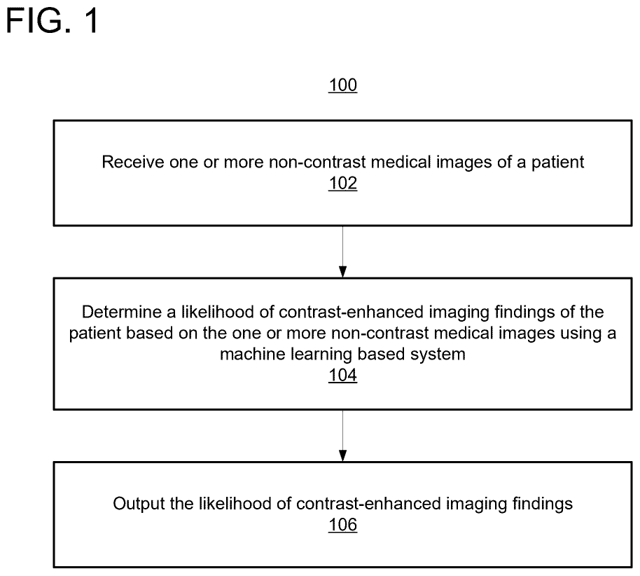

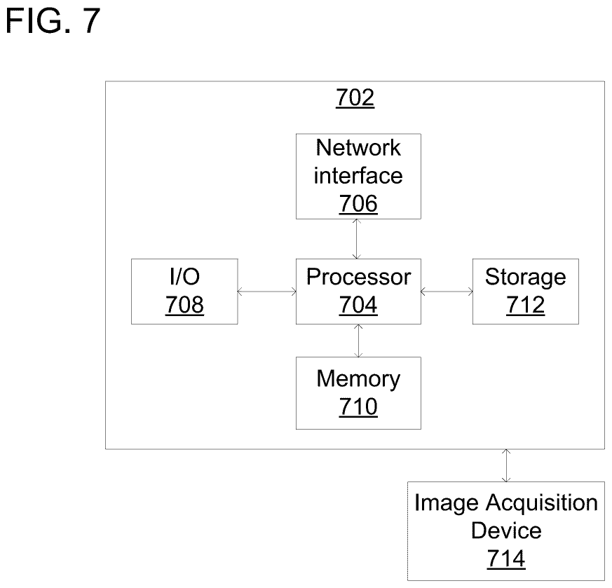

FIG. 1 shows a method 100 for determining the likelihood of contrast-enhanced imaging findings from non-contrast medical images, in accordance with one or more embodiments. The steps and sub-steps of method 100 may be performed by one or more suitable computing devices, such as, e.g., computer 702 of FIG. 7.

At step 102 of FIG. 1, one or more non-contrast medical images of a patient are received. The one or more non-contrast medical images of the patient are medical images of the patient that are acquired without administering a contrast agent to the patient. In one embodiment, the one or more non-contrast medical images depict a cardiovascular system (e.g., the heart and/or vessels) of the patient. However, the non-contrast medical images may depict any other anatomical object of interest of the patient, such as, e.g., other organs, bones, tumors/abnormalities, etc.

In one embodiment, the one or more non-contrast medical images comprise MRI (medical resonance imaging) images, such as, e.g., bSSFP (balanced steady-state free precession) cine images and T1 and T2 mappings. However, the one or more non-contrast medical images may comprise images of any other suitable modality, such as, e.g., CT (computed tomography), US (ultrasound), x-ray, or any other medical imaging modality or combinations of medical imaging modalities. The one or more non-contrast medical images may be 2D (two dimensional) images and/or 3D (three dimensional) volumes, and may comprise a single image or a plurality of images.

The one or more non-contrast medical images may be received, for example, by directly receiving the one or more non-contrast medical images from an image acquisition device (e.g., image acquisition device 714 of FIG. 7) as the one or more non-contrast medical images are acquired, by loading the one or more non-contrast medical images from a storage or memory of a computer system (e.g., storage 712 or memory 710 of computer 702 of FIG. 7), or by receiving the one or more non-contrast medical images from a remote computer system (e.g., computer 702 of FIG. 7). Such a computer system or remote computer system may comprise one or more patient databases, such as, e.g., an EHR (electronic health record), EMR (electronic medical record), PHR (personal health record), HIS (health information system), RIS (radiology information system), PACS (picture archiving and communication system), LIMS (laboratory information management system), or any other suitable database or system.

At step 104 of FIG. 1, a likelihood of contrast-enhanced imaging findings of the patient is determined based on the one or more non-contrast medical images using a machine learning based system. As used herein, the likelihood of contrast-enhanced imaging findings of the patient represents the likelihood that subsequently acquired medical images of the patient, acquired with the administration of a contrast agent to the patient, depict a clinical finding not depicted in the one or more non-contrast medical images. In one embodiment, the contrast agent is a gadolinium based contrast agent. However, the contrast agent may comprise any other suitable contrast agent. The likelihood of contrast-enhanced imaging findings may be represented in any suitable form. For example, the likelihood of contrast-enhanced imaging findings may be a score having a value between zero and one.

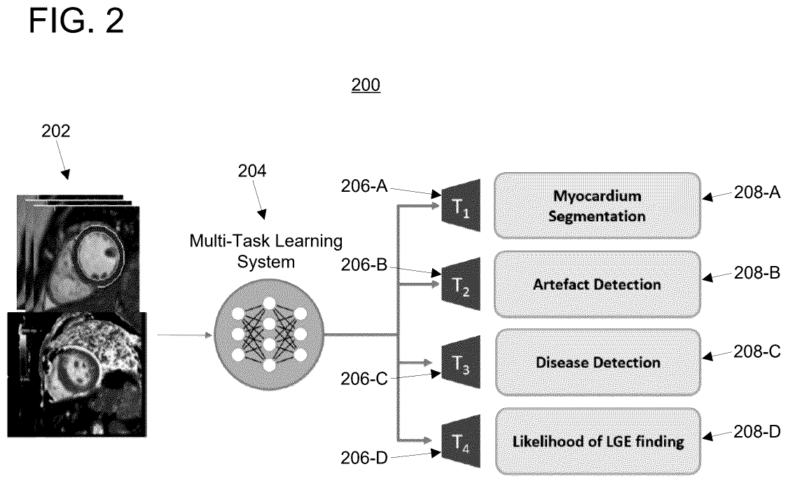

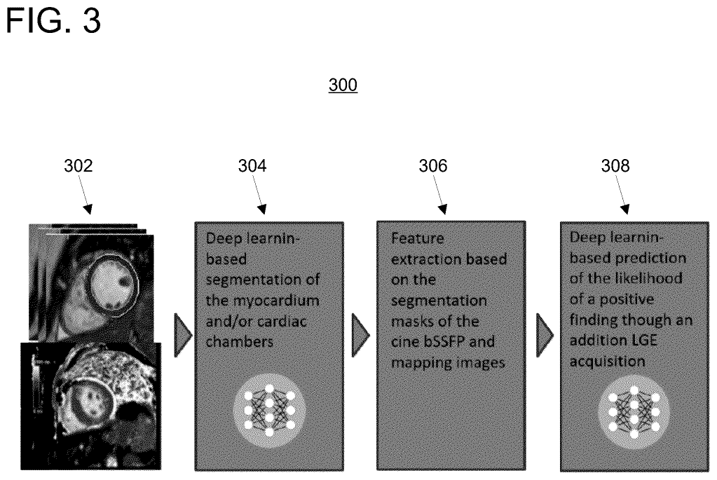

The machine learning based system receives as input the one or more non-contrast medical images and generates as output the likelihood of contrast-enhanced imaging findings. The machine learning based system is trained during a prior offline or training stage using training data. The training data may comprise ground truth data automatically obtained from clinical reports accompanying imaging data. The training data may in addition comprise ground truth definition of the area of enhancement from corresponding contrast-enhanced image data. Once trained, the machine learning based system is applied during an online or inference stage, e.g., to perform step 104 of FIG. 1. The machine learning based system may be implemented using any suitable machine learning based architecture. For example, in some embodiments, the machine learning based system may be implemented as a multi-task learning network as shown in FIG. 2 or as a multi-stage network as shown in FIG. 3.

In one embodiment, the machine learning based system is a multi-task network. The multi-task network comprises multiple decision heads, one for each task, each with a set of separate final activation layers that reflect the nature of each task (e.g., binary, multi-label, or regression task). But the tasks will share the first of the transformations applied to the input. There are different training strategies possible for a multi-task network, but generally the decision heads with their different loss functions are trained in an interleaved manner iteratively feeding the network with a training batch for one decision head after the other starting with the first decision head. During backpropagation the loss functions are combined typically using a weighted average and the model weights are adapted. Then new minibatches are fed again for each task starting again with the first decision head, in an iterative manner. For the training of the multi-task network, the training data may possess a ground truth from some of the decision heads while not for the others. During training the data could be augmented in different ways such as geometric (e.g., cropping, shifting, rotation, zooming, or non-linear transformations) and intensity-based transformation of the image, the introduction of synthetic noise or image artefacts or other automatic image manipulation steps.

FIG. 2 shows a workflow 200 for determining a likelihood of contrast-enhanced imaging findings based on non-contrast medical images using a multi-task learning system, in accordance with one or more embodiments. As shown in workflow 200, multi-task learning system 204 is a neural network model trained with multi-task learning to simultaneously perform a plurality of related medical imaging analysis tasks. Multi-task learning system 204 receives as input non-contrast cardiac MRI images 202 comprising bSSFP cine images and T1 and T2 mappings and generates as output results of a plurality of related medical imaging analysis tasks 208-A, 208-B, 208-C, and 208-D (collectively referred to as tasks 208) using respective task specific heads 206-A, 206-B, 206-C, and 206-D (collectively referred to as task specific heads 206). Tasks 208 comprise the task of determining the likelihood of contrast-enhanced imaging findings, along with one or more supplemental tasks.

In the embodiment shown in workflow 200, the task of determining the likelihood of contrast-enhanced imaging findings is represented as likelihood of LGE finding 208-D performed by task specific head 206-D. The one or more supplemental tasks comprise myocardium segmentation 208-A, artifact detection 208-B, and disease detection 208-C respectively performed by task specific heads 206-A, 206-B, and 206-C of multi-task learning system 204. Myocardium segmentation 208-A is performed on the non-contrast cardiac MRI images 202 to extract the myocardium (or any other organ of interest) and possibly the cardiac chambers visible in the acquired image plane (e.g., left and right ventricles and atria), along with anatomical landmarks such as, e.g., the values and the right ventricular insertion point. Myocardium segmentation 208-A is performed by task specific head 206-A to generate a multi-label segmentation mask for the segmented objects. Artifact detection 208-B is performed by task specific head 206-B to detect any image acquisition artifacts present that may interfere with quantification. Disease detection 208-C is performed by task specific head 206-C to classify the non-contrast cardiac MRI images 202 as being normal or abnormal. For abnormal images, an additional sub-classification task may be performed. The output of task specific head 206-C may comprise probabilities of one or more disease classes, such as, e.g., hypertrophic cardiomyopathy, dilated cardiomyopathy, or myocarditis. The one or more supplemental tasks may comprise any other task related to the task of determining the likelihood of contrast-enhanced imaging findings. Advantageously, multi-task learning system 204 utilizes shared features between tasks 208, thereby improving learning efficiency and task performance.

FIG. 3 shows a workflow 300 for determining a likelihood of contrast-enhanced imaging findings based on non-contrast medical images using a multi-stage network, in accordance with one or more embodiments. The multi-stage network comprises stages 304, 306, and 308 for determining a likelihood of contrast-enhanced imaging findings based on non-contrast cardiac MRI images 302 comprising bSSFP cine images and T1 and T2 mappings.

During a first stage 304, a machine learning based segmentation network receives as input non-contrast cardiac MRI images 302 and generates as output segmentations of one or more anatomical objects of interest. For example, the segmentation network may generate segmentation masks of different classes of the myocardium and the cardiac chambers present in the specific image views (short or long axis), along with anatomical landmarks such as, e.g., the values and the right ventricular insertion point used to determine the corresponding location and orientation of the parts of the myocardium visible in the images. The segmentation network may be implemented as a plurality of separate networks or a joint network, and may be implemented according to any suitable (e.g., well-known) approach.

During a second stage 306, features are extracted from non-contrast cardiac MRI images 302 using the segmentation masks generated during first stage 304. For example, in one embodiment, the features are extracted only from regions of the non-contrast cardiac MRI images 302 that are within the segmentation masks. In another embodiment, the features are extracted from the entirety of non-contrast cardiac MRI images 302 with more weight given to features extracted within the segmentation masks.

The features may comprise any suitable feature extracted from non-contrast cardiac MRI images 302. In one embodiment, the features comprise features characterizing the volume and geometry of the cardiac chambers (or any other anatomical object of interest), such as, e.g., volume at end-systole and end-diastole, stroke volumes, ejection fractions, etc. In another embodiment, the features comprise features characterizing deformation, such as, e.g., displacement, velocity, and strain measures, which can be global measures or measures per segment (e.g., using the AHA (American Heart Association) 16-segment model), and can be computed either for the entire myocardium or for the endocardial, epicardial, and/or mid-wall regions separately. In another embodiment, the features comprise quantitative statistics or texture features derived from the T1 and T2 mappings. In another embodiment, the features comprise latent features extracted by a machine learning based feature extractor network. In another embodiment, the features comprise radiomic features. The features may be extracted using any suitable approach, such as, e.g., by utilizing a (e.g., well-known) machine learning based network. In one embodiment, the extracted features may be supplemented with other clinical parameters, such as, e.g., age, height, weight, heart rate, systolic and diastolic blood pressure, etc. of the patient.

During a third stage 308, a machine learning based classification network determines a likelihood of contrast-enhanced imaging findings based on the extracted (or enhanced) features. The classification network receives as input the extracted (or enhanced) features extracted during second stage 306 and generates as output the likelihood of contrast-enhanced imaging findings.

Referring back to FIG. 1, at step 106, the likelihood of contrast-enhanced imaging findings is output. For example, the likelihood of contrast-enhanced imaging findings can be output by displaying the likelihood of contrast-enhanced imaging findings on a display device of a computer system (e.g., I/O 708 of computer 702 of FIG. 7), storing the likelihood of contrast-enhanced imaging findings on a memory or storage of a computer system (e.g., memory 710 or storage 712 of computer 702 of FIG. 7), or by transmitting the likelihood of contrast-enhanced imaging findings to a remote computer system (e.g., computer 702 of FIG. 7).

In one embodiment, method 100 of FIG. 1 is performed to determine the likelihood of contrast-enhanced imaging findings during a CRM exam. In this embodiment, method 100 is performed after acquisition of the one or more non-contrast medical images but before starting acquisition of contrast-enhanced medical images. In one embodiment, contrast-enhanced medical images of the patient are acquired based on the likelihood of contrast-enhanced imaging findings. For example, in response to determining that contrast-enhanced imaging findings is likely based on the likelihood, a contrast agent is administered to the patient and contrast-enhanced medical images of the patient are acquired. The contrast-enhanced imaging findings may be determined to be likely by, for example, comparing the likelihood to a threshold.

Advantageously, embodiments described herein provide for the prediction of the likelihood of contrast-enhanced imaging findings based on previously acquired non-contrast images in real time during the CMR exam at the scanner. The predicted likelihood of contrast-enhanced imaging findings can contribute to the decision of whether to inject the patient with a contrast agent to additionally acquire contrast-enhanced images, with the potential to reduce the amount of unnecessarily acquired contrast-enhanced images.

Another advantage is that, by utilizing the multi-task learning approach, less training data is required as compared to separately training networks to perform each task. Since the tasks performed by the multi-task learning system are not only complementary but intrinsically linked to the task of determining a likelihood of contrast-enhanced imaging findings, the multi-task learning system is better able to capture image patterns that are relevant across all tasks, thereby increasing performance.

Further, by utilizing the multi-stage network, the task of determining a likelihood of contrast-enhanced imaging findings may be performed based on features that were previously automatically extracted (e.g., using a machine learning based network) along with additional clinical parameters. One advantage of this approach is that it is more transparent and could be explained in the context of clinical decision guidelines. This could increase user confidence to follow the proposed course of action.

Embodiments described herein are described with respect to the claimed systems as well as with respect to the claimed methods. Features, advantages or alternative embodiments herein can be assigned to the other claimed objects and vice versa. In other words, claims and embodiments for the systems can be improved with features described or claimed in the context of the respective methods. In this case, the functional features of the method are implemented by physical units of the system.

Furthermore, certain embodiments described herein are described with respect to methods and systems utilizing trained machine learning models, as well as with respect to methods and systems for providing trained machine learning models. Features, advantages or alternative embodiments herein can be assigned to the other claimed objects and vice versa. In other words, claims and embodiments for providing trained machine learning models can be improved with features described or claimed in the context of utilizing trained machine learning models, and vice versa. In particular, datasets used in the methods and systems for utilizing trained machine learning models can have the same properties and features as the corresponding datasets used in the methods and systems for providing trained machine learning models, and the trained machine learning models provided by the respective methods and systems can be used in the methods and systems for utilizing the trained machine learning models.

In general, a trained machine learning model mimics cognitive functions that humans associate with other human minds. In particular, by training based on training data the machine learning model is able to adapt to new circumstances and to detect and extrapolate patterns. Another term for “trained machine learning model” is “trained function.”

In general, parameters of a machine learning model can be adapted by means of training. In particular, supervised training, semi-supervised training, unsupervised training, reinforcement learning and/or active learning can be used. Furthermore, representation learning (an alternative term is “feature learning”) can be used. In particular, the parameters of the machine learning models can be adapted iteratively by several steps of training. In particular, within the training a certain cost function can be minimized. In particular, within the training of a neural network the backpropagation algorithm can be used.

In particular, a machine learning model, such as, e.g., the machine learning based system utilized at step 104 of FIG. 1, the multi-task learning system 204 and heads 206 of FIG. 2, and the segmentation network utilized at stage 304, the feature extractor network utilized at stage 306, and the classifier network utilized at stage 308 of FIG. 3, can comprise, for example, a neural network, a support vector machine, a decision tree and/or a Bayesian network, and/or the machine learning model can be based on, for example, k-means clustering, Q-learning, genetic algorithms and/or association rules. In particular, a neural network can be, e.g., a deep neural network, a convolutional neural network or a convolutional deep neural network. Furthermore, a neural network can be, e.g., an adversarial network, a deep adversarial network and/or a generative adversarial network.

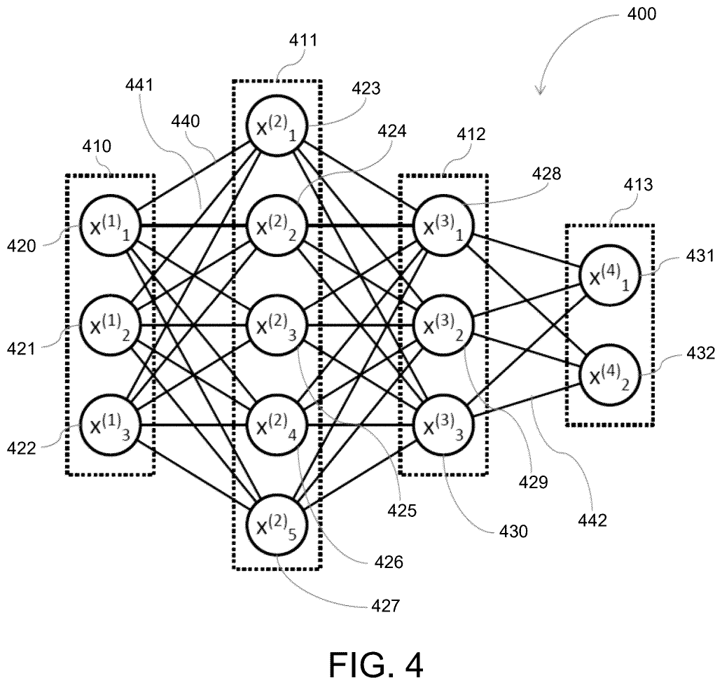

FIG. 4 shows an embodiment of an artificial neural network 400 that may be used to implement one or more machine learning models described herein. Alternative terms for “artificial neural network” are “neural network”, “artificial neural net” or “neural net”.

The artificial neural network 400 comprises nodes 420, . . . , 432 and edges 440, 442, wherein each edge 440, . . . , 442 is a directed connection from a first node 420, . . . 432 to a second node 420, . . . , 432. In general, the first node 420, . . . , 432 and the second node 420, . . . , 432 are different nodes 420, . . . , 432, it is also possible that the first node 420, . . . 432 and the second node 420, . . . , 432 are identical. For example, in FIG. 4 the edge 440 is a directed connection from the node 420 to the node 423, and the edge 442 is a directed connection from the node 430 to the node 432. An edge 440, . . . , 442 from a first node 420, 432 to a second node 420, . . . , 432 is also denoted as “ingoing edge” for the second node 420, . . . , 432 and as “outgoing edge” for the first node 420, . . . , 432.

In this embodiment, the nodes 420, . . . , 432 of the artificial neural network 400 can be arranged in layers 410, . . . , 413, wherein the layers can comprise an intrinsic order introduced by the edges 440, . . . , 442 between the nodes 420, . . . , 432. In particular, edges 440, . . . , 442 can exist only between neighboring layers of nodes. In the displayed embodiment, there is an input layer 410 comprising only nodes 420, . . . , 422 without an incoming edge, an output layer 413 comprising only nodes 431, 432 without outgoing edges, and hidden layers 411, 412 in-between the input layer 410 and the output layer 413. In general, the number of hidden layers 411, 412 can be chosen arbitrarily. The number of nodes 420, . . . , 422 within the input layer 410 usually relates to the number of input values of the neural network, and the number of nodes 431, 432 within the output layer 413 usually relates to the number of output values of the neural network.

In particular, a (real) number can be assigned as a value to every node 420, . . . , 432 of the neural network 400. Here, x⁽ⁿ⁾ᵢ denotes the value of the i-th node 420, . . . , 432 of the n-th layer 410, . . . , 413. The values of the nodes 420, . . . , 422 of the input layer 410 are equivalent to the input values of the neural network 400, the values of the nodes 431, 432 of the output layer 413 are equivalent to the output value of the neural network 400. Furthermore, each edge 440, . . . , 442 can comprise a weight being a real number, in particular, the weight is a real number within the interval [−1, 1] or within the interval [0, 1]. Here, w^{(m,n)}_{i,j} denotes the weight of the edge between the i-th node 420, . . . , 432 of the m-th layer 410, . . . , 413 and the j-th node 420, . . . , 432 of the n-th layer 410, . . . , 413. Furthermore, the abbreviation w⁽ⁿ⁾_{i,j} is defined for the weight w^{(n,n+1)}_{i,j}.

In particular, to calculate the output values of the neural network 400, the input values are propagated through the neural network. In particular, the values of the nodes 420, . . . , 432 of the (n+1)-th layer 410, . . . , 413 can be calculated based on the values of the nodes 420, . . . , 432 of the n-th layer 410, . . . , 413 by

$${x}^{{( n + 1 )}_{j}} = f ( {\sum }_{i} {x}^{{( n )}_{i}} \cdot {w}^{{( n )}_{i , j}} ) .$$

Herein, the function f is a transfer function (another term is “activation function”). Known transfer functions are step functions, sigmoid function (e.g., the logistic function, the generalized logistic function, the hyperbolic tangent, the Arctangent function, the error function, the smoothstep function) or rectifier functions. The transfer function is mainly used for normalization purposes.

In particular, the values are propagated layer-wise through the neural network, wherein values of the input layer 410 are given by the input of the neural network 400, wherein values of the first hid-den layer 411 can be calculated based on the values of the input layer 410 of the neural network, wherein values of the second hidden layer 412 can be calculated based in the values of the first hidden layer 411, etc.

In order to set the values w^{(m,n)}_{i,j} for the edges, the neural network 400 has to be trained using training data. In particular, training data comprises training input data and training output data (denoted as tᵢ). For a training step, the neural network 400 is applied to the training input data to generate calculated output data. In particular, the training data and the calculated output data comprise a number of values, said number being equal with the number of nodes of the output layer.

In particular, a comparison between the calculated output data and the training data is used to recursively adapt the weights within the neural network 400 (backpropagation algorithm). In particular, the weights are changed according to

$${w}^{{′ ( n )}_{i , j}} = {w}^{{( n )}_{i , j}} - γ \cdot {δ}^{{( n )}_{j}} \cdot {x}^{{( n )}_{i}}$$

wherein γ is a learning rate, and the numbers δ⁽ⁿ⁾ⱼ can be recursively calculated as

$${δ}^{{( n )}_{j}} = ( {\sum }_{k} {δ}^{{( n + 1 )}_{k}} \cdot {w}^{{( n + 1 )}_{j , k}} ) \cdot {f}^{′} ( {\sum }_{i} {x}^{{( n )}_{i}} \cdot {w}^{{( n )}_{i , j}} )$$

based on δ⁽ⁿ⁺¹⁾ⱼ, if the (n+1)-th layer is not the output layer, and

$${δ}^{{( n )}_{j}} = ( {x}^{{( n + 1 )}_{j}} - {t}^{{( n + 1 )}_{j}} ) \cdot {f}^{′} ( {x}^{{( n )}_{i}} \cdot {w}^{{( n )}_{i , j}} )$$

if the (n+1)-th layer is the output layer 413, wherein f′ is the first derivative of the activation function, and t⁽ⁿ⁺¹⁾ⱼ is the comparison training value for the j-th node of the output layer 413.

A convolutional neural network is a neural network that uses a convolution operation instead general matrix multiplication in at least one of its layers (so-called “convolutional layer”). In particular, a convolutional layer performs a dot product of one or more convolution kernels with the convolutional layer's input data/image, wherein the entries of the one or more convolution kernel are the parameters or weights that are adapted by training. In particular, one can use the Frobenius inner product and the ReLU activation function. A convolutional neural network can comprise additional layers, e.g., pooling layers, fully connected layers, and normalization layers.

By using convolutional neural networks input images can be processed in a very efficient way, because a convolution operation based on different kernels can extract various image features, so that by adapting the weights of the convolution kernel the relevant image features can be found during training. Furthermore, based on the weight-sharing in the convolutional kernels less parameters need to be trained, which prevents overfitting in the training phase and allows to have faster training or more layers in the network, improving the performance of the network.

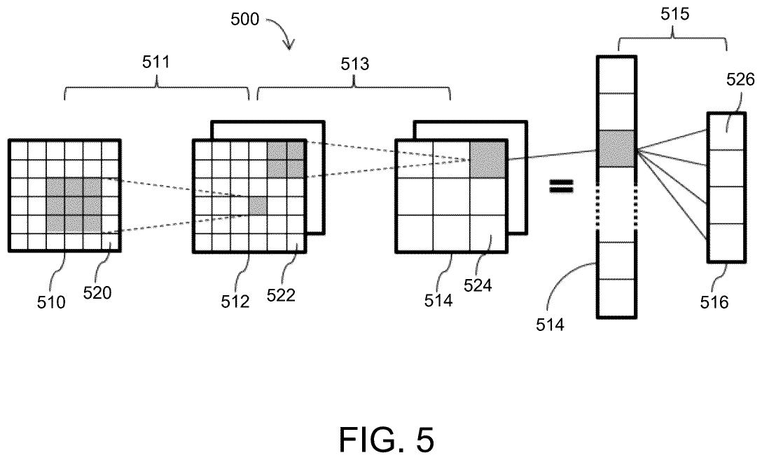

FIG. 5 shows an embodiment of a convolutional neural network 500 that may be used to implement one or more machine learning models described herein. In the displayed embodiment, the convolutional neural network comprises 500 an input node layer 510, a convolutional layer 511, a pooling layer 513, a fully connected layer 514 and an output node layer 516, as well as hidden node layers 512, 514. Alternatively, the convolutional neural network 500 can comprise several convolutional layers 511, several pooling layers 513 and several fully connected layers 515, as well as other types of layers. The order of the layers can be chosen arbitrarily, usually fully connected layers 515 are used as the last layers before the output layer 516.

In particular, within a convolutional neural network 500 nodes 520, 522, 524 of a node layer 510, 512, 514 can be considered to be arranged as a d-dimensional matrix or as a d-dimensional image. In particular, in the two-dimensional case the value of the node 520, 522, 524 indexed with i and j in the n-th node layer 510, 512, 514 can be denoted as x(n)[i, j]. However, the arrangement of the nodes 520, 522, 524 of one node layer 510, 512, 514 does not have an effect on the calculations executed within the convolutional neural network 500 as such, since these are given solely by the structure and the weights of the edges.

A convolutional layer 511 is a connection layer between an anterior node layer 510 (with node values x(n−1)) and a posterior node layer 512 (with node values x(n)). In particular, a convolutional layer 511 is characterized by the structure and the weights of the incoming edges forming a convolution operation based on a certain number of kernels. In particular, the structure and the weights of the edges of the convolutional layer 511 are chosen such that the values x(n) of the nodes 522 of the posterior node layer 512 are calculated as a convolution x(n)=K*x(n−1) based on the values x(n−1) of the nodes 520 anterior node layer 510, where the convolution * is defined in the two-dimensional case as

$${x}_{k}^{( n )} [ i , j ] = ( K * {x}^{( n - 1 )} ) [ i , j ] = {\sum }_{{i}^{′}} {\sum }_{{j}^{′}} K [ {i}^{′} , {j}^{′} ] \cdot {x}^{( n - 1 )} [ i - {i}^{′} , j - {j}^{′} ] .$$

Here the kernel K is a d-dimensional matrix (in this embodiment, a two-dimensional matrix), which is usually small compared to the number of nodes 520, 522 (e.g., a 3×3 matrix, or a 5×5 matrix). In particular, this implies that the weights of the edges in the convolution layer 511 are not independent, but chosen such that they produce said convolution equation. In particular, for a kernel being a 3×3 matrix, there are only 9 independent weights (each entry of the kernel matrix corresponding to one independent weight), irrespectively of the number of nodes 520, 522 in the anterior node layer 510 and the posterior node layer 512.

In general, convolutional neural networks 500 use node layers 510, 512, 514 with a plurality of channels, in particular, due to the use of a plurality of kernels in convolutional layers 511. In those cases, the node layers can be considered as (d+1)-dimensional matrices (the first dimension indexing the channels). The action of a convolutional layer 511 is then a two-dimensional example defined as

$${x}^{{( n )}_{b}} [ i , j ] = {\sum }_{a} {K}_{a , b} * {x}^{{( n - 1 )}_{a}} [ i , j ] = {\sum }_{a} {\sum }_{{i}^{′}} {\sum }_{{j}^{′}} {K}_{a , b} [ {i}^{′} , {j}^{′} ] \cdot {x}^{{( n - 1 )}_{a}} [ i - {i}^{′} , j - {j}^{′} ]$$

where x⁽ⁿ⁻¹⁾^{ₐ} corresponds to the a-th channel of the anterior node layer 510, x⁽ⁿ⁾^{_{b}} corresponds to the b-th channel of the posterior node layer 512 and K_{a,b} corresponds to one of the kernels. If a convolutional layer 511 acts on an anterior node layer 510 with A channels and outputs a posterior node layer 512 with B channels, there are A·B independent d-dimensional kernels K_{a,b}.

In general, in convolutional neural networks 500 activation functions are used. In this embodiment re ReLU (acronym for “Rectified Linear Units”) is used, with R(z)=max(0, z), so that the action of the convolutional layer 511 in the two-dimensional example is

$${x}^{{( n )}_{b}} [ i , j ] = R ( {\sum }_{a} ( {K}_{a , b} * {x}^{{( n - 1 )}_{a}} ) [ i , j ] ) = R ( {\sum }_{a} {\sum }_{{i}^{′}} {\sum }_{{j}^{′}} {K}_{a , b} [ {i}^{′} , {j}^{′} ] \cdot {x}^{{( n - 1 )}_{a}} [ i - {i}^{′} , j - {j}^{′} ] )$$

It is also possible to use other activation functions, e.g., ELU (acronym for “Exponential Linear Unit”), LeakyReLU, Sigmoid, Tanh or Softmax.

In the displayed embodiment, the input layer 510 comprises 36 nodes 520, arranged as a two-dimensional 6×6 matrix. The first hidden node layer 512 comprises 72 nodes 522, arranged as two two-dimensional 6×6 matrices, each of the two matrices being the result of a convolution of the values of the input layer with a 3×3 kernel within the convolutional layer 511. Equivalently, the nodes 522 of the first hidden node layer 512 can be interpreted as arranged as a three-dimensional 2×6×6 matrix, wherein the first dimension correspond to the channel dimension.

The advantage of using convolutional layers 511 is that spatially local correlation of the input data can exploited by enforcing a local connectivity pattern between nodes of adjacent layers, in particular by each node being connected to only a small region of the nodes of the preceding layer.

A pooling layer 513 is a connection layer between an anterior node layer 512 (with node values x(n−1)) and a posterior node layer 514 (with node values x(n)). In particular, a pooling layer 513 can be characterized by the structure and the weights of the edges and the activation function forming a pooling operation based on a non-linear pooling function f. For example, in the two-dimensional case the values x(n) of the nodes 524 of the posterior node layer 514 can be calculated based on the values x(n−1) of the nodes 522 of the anterior node layer 512 as

$${x}^{{( n )}_{b}} [ i , j ] = f ( {x}^{( n - 1 )} [ {id}_{1} , {jd}_{2} ] , ... , {x}^{{( n - 1 )}_{b}} [ ( i + 1 ) {d}_{1} - 1 , ( j + 1 ) {d}_{2} - 1 ] )$$

In other words, by using a pooling layer 513 the number of nodes 522, 524 can be reduced, by re-placing a number d1·d2 of neighboring nodes 522 in the anterior node layer 512 with a single node 522 in the posterior node layer 514 being calculated as a function of the values of said number of neighboring nodes. In particular, the pooling function f can be the max-function, the average or the L2-Norm. In particular, for a pooling layer 513 the weights of the incoming edges are fixed and are not modified by training.

The advantage of using a pooling layer 513 is that the number of nodes 522, 524 and the number of parameters is reduced. This leads to the amount of computation in the network being reduced and to a control of overfitting.

In the displayed embodiment, the pooling layer 513 is a max-pooling layer, replacing four neighboring nodes with only one node, the value being the maximum of the values of the four neighboring nodes. The max-pooling is applied to each d-dimensional matrix of the previous layer; in this embodiment, the max-pooling is applied to each of the two two-dimensional matrices, reducing the number of nodes from 72 to 18.

In general, the last layers of a convolutional neural network 500 are fully connected layers 515. A fully connected layer 515 is a connection layer between an anterior node layer 514 and a posterior node layer 516. A fully connected layer 513 can be characterized by the fact that a majority, in particular, all edges between nodes 514 of the anterior node layer 514 and the nodes 516 of the posterior node layer are present, and wherein the weight of each of these edges can be adjusted individually.

In this embodiment, the nodes 524 of the anterior node layer 514 of the fully connected layer 515 are displayed both as two-dimensional matrices, and additionally as non-related nodes (indicated as a line of nodes, wherein the number of nodes was reduced for a better presentability). This operation is also denoted as “flattening”. In this embodiment, the number of nodes 526 in the posterior node layer 516 of the fully connected layer 515 smaller than the number of nodes 524 in the anterior node layer 514. Alternatively, the number of nodes 526 can be equal or larger.

Furthermore, in this embodiment the Softmax activation function is used within the fully connected layer 515. By applying the Softmax function, the sum the values of all nodes 526 of the output layer 516 is 1, and all values of all nodes 526 of the output layer 516 are real numbers between 0 and 1. In particular, if using the convolutional neural network 500 for categorizing input data, the values of the output layer 516 can be interpreted as the probability of the input data falling into one of the different categories.

In particular, convolutional neural networks 500 can be trained based on the backpropagation algorithm. For preventing overfitting, methods of regularization can be used, e.g., dropout of nodes 520, . . . , 524, stochastic pooling, use of artificial data, weight decay based on the L1 or the L2 norm, or max norm constraints.

According to an aspect, the machine learning model may comprise one or more residual networks (ResNet). In particular, a ResNet is an artificial neural network comprising at least one jump or skip connection used to jump over at least one layer of the artificial neural network. In particular, a ResNet may be a convolutional neural network comprising one or more skip connections respectively skipping one or more convolutional layers. According to some examples, the ResNets may be represented as m-layer ResNets, where m is the number of layers in the corresponding architecture and, according to some examples, may take values of 34, 50, 101, or 152. According to some examples, such an m-layer ResNet may respectively comprise (m−2)/2 skip connections.

A skip connection may be seen as a bypass which directly feeds the output of one preceding layer over one or more bypassed layers to a layer succeeding the one or more bypassed layers. Instead of having to directly fit a desired mapping, the bypassed layers would then have to fit a residual mapping “balancing” the directly fed output.

Fitting the residual mapping is computationally easier to optimize than the directed mapping. What is more, this alleviates the problem of vanishing/exploding gradients during optimization upon training the machine learning models: if a bypassed layer runs into such problems, its contribution may be skipped by regularization of the directly fed output. Using ResNets thus brings about the advantage that much deeper networks may be trained.

In particular, a recurrent machine learning model is a machine learning model whose output does not only depend on the input value and the parameters of the machine learning model adapted by the training process, but also on a hidden state vector, wherein the hidden state vector is based on previous inputs used on for the recurrent machine learning model. In particular, the recurrent machine learning model can comprise additional storage states or additional structures that incorporate time delays or comprise feedback loops.

In particular, the underlying structure of a recurrent machine learning model can be a neural network, which can be denoted as recurrent neural network. Such a recurrent neural network can be described as an artificial neural network where connections between nodes form a directed graph along a temporal sequence. In particular, a recurrent neural network can be interpreted as directed acyclic graph. In particular, the recurrent neural network can be a finite impulse recurrent neural network or an infinite impulse recurrent neural network (wherein a finite impulse network can be unrolled and replaced with a strictly feedforward neural network, and an infinite impulse network cannot be unrolled and replaced with a strictly feedforward neural network).

In particular, training a recurrent neural network can be based on the BPTT algorithm (acronym for “backpropagation through time”), on the RTRL algorithm (acronym for “real-time recurrent learning”) and/or on genetic algorithms.

By using a recurrent machine learning model input data comprising sequences of variable length can be used. In particular, this implies that the method cannot be used only for a fixed number of input datasets (and needs to be trained differently for every other number of input datasets used as input), but can be used for an arbitrary number of input datasets. This implies that the whole set of training data, independent of the number of input datasets contained in different sequences, can be used within the training, and that training data is not reduced to training data corresponding to a certain number of successive input datasets.

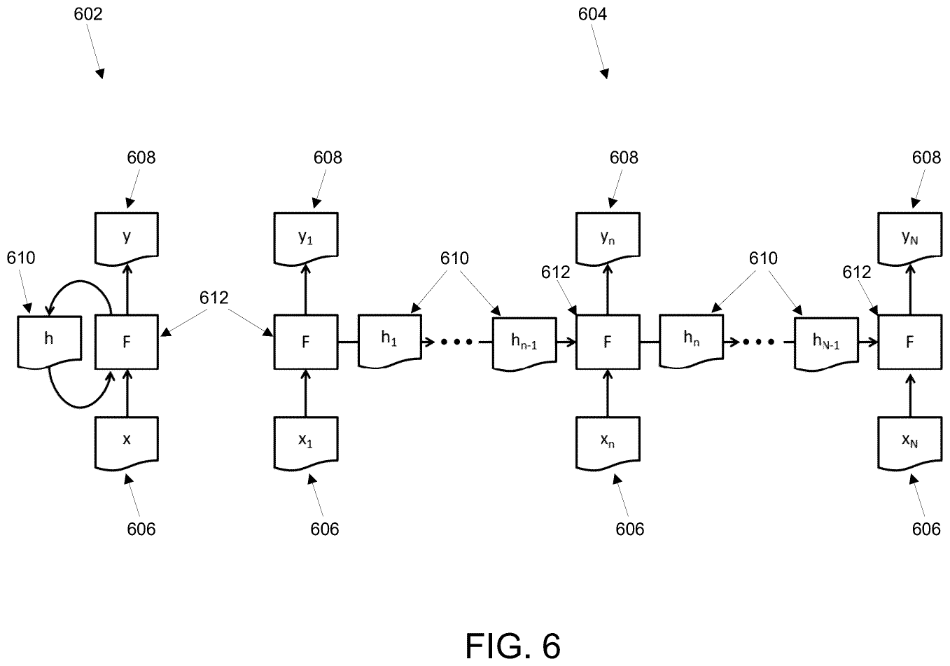

FIG. 6 shows the schematic structure of a recurrent machine learning model F, both in a recurrent representation 602 and in an unfolded representation 604, that may be used to implement one or more machine learning models described herein. The recurrent machine learning model takes as input several input datasets x, x₁, . . . , x_{N} 606 and creates a corresponding set of output datasets y, y₁, . . . , y_{N} 608. Furthermore, the output depends on a so-called hidden vector h, h₁, . . . , h_{N} 610, which implicitly comprises information about input datasets previously used as input for the recurrent machine learning model F 612. By using these hidden vectors h, h₁, . . . , h_{N} 610, a sequentiality of the input datasets can be leveraged.

In a single step of the processing, the recurrent machine learning model F 612 takes as input the hidden vector hₙ₋₁ created within the previous step and an input dataset xₙ. Within this step, the recurrent machine learning model F generates as output an updated hidden vector hₙ and an output dataset yₙ. In other words, one step of processing calculates (yₙ, hₙ)=F(xₙ, hₙ₋₁), or by splitting the recurrent machine learning model F 612 into a part F(y) calculating the output data and F(h) calculating the hidden vector, one step of processing calculates yₙ=F^{(y)}(xₙ, hₙ₋₁) and hₙ=F^{(h)}(xₙ, hₙ₋₁). For the first processing step, h₀ can be chosen randomly or filled with all entries being zero. The parameters of the recurrent machine learning model F 612 that were trained based on training datasets before do not change between the different processing steps.

In particular, the output data and the hidden vector of a processing step depend on all the previous input datasets used in the previous steps. yₙ=F^{(y)}(xₙ, F^{(h)}(xₙ₋₁, hₙ₋₂)) and hₙ=F(h)(xₙ, F^{(h)}(xₙ₋₁, hₙ₋₂)).

Systems, apparatuses, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Systems, apparatuses, and methods described herein may be implemented using computers operating in a client-server relationship. Typically, in such a system, the client computers are located remotely from the server computer and interact via a network. The client-server relationship may be defined and controlled by computer programs running on the respective client and server computers.

Systems, apparatuses, and methods described herein may be implemented within a network-based cloud computing system. In such a network-based cloud computing system, a server or another processor that is connected to a network communicates with one or more client computers via a network. A client computer may communicate with the server via a network browser application residing and operating on the client computer, for example. A client computer may store data on the server and access the data via the network. A client computer may transmit requests for data, or requests for online services, to the server via the network. The server may perform requested services and provide data to the client computer(s). The server may also transmit data adapted to cause a client computer to perform a specified function, e.g., to perform a calculation, to display specified data on a screen, etc. For example, the server may transmit a request adapted to cause a client computer to perform one or more of the steps or functions of the methods and workflows described herein, including one or more of the steps or functions of FIGS. 1-3. Certain steps or functions of the methods and workflows described herein, including one or more of the steps or functions of FIGS. 1-3, may be performed by a server or by another processor in a network-based cloud-computing system. Certain steps or functions of the methods and workflows described herein, including one or more of the steps of FIGS. 1-3, may be performed by a client computer in a network-based cloud computing system. The steps or functions of the methods and workflows described herein, including one or more of the steps of FIGS. 1-3, may be performed by a server and/or by a client computer in a network-based cloud computing system, in any combination.

Systems, apparatuses, and methods described herein may be implemented using a computer program product tangibly embodied in an information carrier, e.g., in a non-transitory machine-readable storage device, for execution by a programmable processor; and the method and workflow steps described herein, including one or more of the steps or functions of FIGS. 1-3, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

A high-level block diagram of an example computer 702 that may be used to implement systems, apparatuses, and methods described herein is depicted in FIG. 7. Computer 702 includes a processor 704 operatively coupled to a data storage device 712 and a memory 710. Processor 704 controls the overall operation of computer 702 by executing computer program instructions that define such operations. The computer program instructions may be stored in data storage device 712, or other computer readable medium, and loaded into memory 710 when execution of the computer program instructions is desired. Thus, the method and workflow steps or functions of FIGS. 1-3 can be defined by the computer program instructions stored in memory 710 and/or data storage device 712 and controlled by processor 704 executing the computer program instructions. For example, the computer program instructions can be implemented as computer executable code programmed by one skilled in the art to perform the method and workflow steps or functions of FIGS. 1-3. Accordingly, by executing the computer program instructions, the processor 704 executes the method and workflow steps or functions of FIGS. 1-3. Computer 702 may also include one or more network interfaces 706 for communicating with other devices via a network. Computer 702 may also include one or more input/output devices 708 that enable user interaction with computer 702 (e.g., display, keyboard, mouse, speakers, buttons, etc.).

Processor 704 may include both general and special purpose microprocessors, and may be the sole processor or one of multiple processors of computer 702. Processor 704 may include one or more central processing units (CPUs), for example. Processor 704, data storage device 712, and/or memory 710 may include, be supplemented by, or incorporated in, one or more application-specific integrated circuits (ASICs) and/or one or more field programmable gate arrays (FPGAs).

Data storage device 712 and memory 710 each include a tangible non-transitory computer readable storage medium. Data storage device 712, and memory 710, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 708 may include peripherals, such as a printer, scanner, display screen, etc. For example, input/output devices 708 may include a display device such as a cathode ray tube (CRT) or liquid crystal display (LCD) monitor for displaying information to the user, a keyboard, and a pointing device such as a mouse or a trackball by which the user can provide input to computer 702.

An image acquisition device 714 can be connected to the computer 702 to input image data (e.g., medical images) to the computer 702. It is possible to implement the image acquisition device 714 and the computer 702 as one device. It is also possible that the image acquisition device 714 and the computer 702 communicate wirelessly through a network. In a possible embodiment, the computer 702 can be located remotely with respect to the image acquisition device 714.

Any or all of the systems, apparatuses, and methods discussed herein may be implemented using one or more computers such as computer 702.

One skilled in the art will recognize that an implementation of an actual computer or computer system may have other structures and may contain other components as well, and that FIG. 7 is a high level representation of some of the components of such a computer for illustrative purposes.

Independent of the grammatical term usage, individuals with male, female or other gender identities are included within the term.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

The following is a list of non-limiting illustrative embodiments disclosed herein:
Illustrative embodiment 1. A computer-implemented method comprising: receiving one or more non-contrast medical images of a patient; determining a likelihood of contrast-enhanced imaging findings of the patient based on the one or more non-contrast medical images using a machine learning based system; and outputting the likelihood of contrast-enhanced imaging findings.
Illustrative embodiment 2. The computer-implemented method of illustrative embodiment 1, wherein determining a likelihood of contrast-enhanced imaging findings of the patient based on the one or more non-contrast medical images using a machine learning based system comprises: simultaneously performing a plurality of medical imaging analysis tasks based on the one or more non-contrast medical images using a multi-task learning system, the plurality of medical imaging analysis tasks comprising the determining the likelihood of contrast-enhanced imaging findings and one or more supplemental tasks.
Illustrative embodiment 3. The computer-implemented method of illustrative embodiment 2, wherein the one or more supplemental tasks comprise at least one of segmentation, artifact detection, and disease detection.
Illustrative embodiment 4. The computer-implemented method of any one of illustrative embodiments 1-3, wherein determining a likelihood of contrast-enhanced imaging findings of the patient based on the one or more non-contrast medical images using a machine learning based system comprises: segmenting one or more anatomical objects from the one or more non-contrast medical images using a machine learning based segmentation network; extracting features from the one or more non-contrast medical images based on results of the segmentation; and determining the likelihood of contrast-enhanced imaging findings based on the extracted features using a machine learning based classification network.
Illustrative embodiment 5. The computer-implemented method of illustrative embodiment 4, wherein the features comprise at least one of features characterizing volume and geometry of the one or more anatomical objects, feature characterizing deformation of the one or more anatomical objects, quantitative statistics or texture features of the one or more anatomical objects, latent features extracted by a machine learning based feature extractor network, or radiomic features.
Illustrative embodiment 6. The computer-implemented method of any one of illustrative embodiments 4-5, further comprising supplementing the extracted features with clinical parameters, wherein determining the likelihood of contrast-enhanced imaging findings based on the extracted features using a machine learning based classification network comprises: determining the likelihood of contrast-enhanced imaging findings based on the supplemented extracted features using the machine learning based classification network.
Illustrative embodiment 7. The computer-implemented method of any one of illustrative embodiments 1-6, wherein the receiving, the determining, and the outputting are performed after acquisition of the one or more non-contrast medical images and before acquisition of contrast-enhanced medical images.
Illustrative embodiment 8. The computer-implemented method of any one of illustrative embodiments 1-7, further comprising: acquiring contrast-enhanced medical images of the patient based on the likelihood of contrast-enhanced imaging findings.
Illustrative embodiment 9. The computer-implemented method of any one of illustrative embodiments 1-8, wherein the one or more non-contrast medical images comprises bSSFP (balanced steady-state free precession) cine images and T1 and T2 mappings.
Illustrative embodiment 10. An apparatus comprising: means for receiving one or more non-contrast medical images of a patient; means for determining a likelihood of contrast-enhanced imaging findings of the patient based on the one or more non-contrast medical images using a machine learning based system; and means for outputting the likelihood of contrast-enhanced imaging findings.
Illustrative embodiment 11. The apparatus of illustrative embodiment 10, wherein the means for determining a likelihood of contrast-enhanced imaging findings of the patient based on the one or more non-contrast medical images using a machine learning based system comprises: means for simultaneously performing a plurality of medical imaging analysis tasks based on the one or more non-contrast medical images using a multi-task learning system, the plurality of medical imaging analysis tasks comprising the determining the likelihood of contrast-enhanced imaging findings and one or more supplemental tasks.
Illustrative embodiment 12. The apparatus of illustrative embodiment 11, wherein the one or more supplemental tasks comprise at least one of segmentation, artifact detection, and disease detection.
Illustrative embodiment 13. The apparatus of any one of illustrative embodiments 10-12, wherein the means for determining a likelihood of contrast-enhanced imaging findings of the patient based on the one or more non-contrast medical images using a machine learning based system comprises: means for segmenting one or more anatomical objects from the one or more non-contrast medical images using a machine learning based segmentation network; means for extracting features from the one or more non-contrast medical images based on results of the segmentation; and means for determining the likelihood of contrast-enhanced imaging findings based on the extracted features using a machine learning based classification network.
Illustrative embodiment 14. The apparatus of any one of illustrative embodiments 10-13, wherein the means for receiving, the means for determining, and the means for outputting are performed after acquisition of the one or more non-contrast medical images and before acquisition of contrast-enhanced medical images.
Illustrative embodiment 15. A non-transitory computer-readable storage medium comprising instructions which, when executed by a computer, cause the computer to carry out operations comprising: receiving one or more non-contrast medical images of a patient; determining a likelihood of contrast-enhanced imaging findings of the patient based on the one or more non-contrast medical images using a machine learning based system; and outputting the likelihood of contrast-enhanced imaging findings.
Illustrative embodiment 16. The non-transitory computer-readable storage medium of illustrative embodiment 15, wherein determining a likelihood of contrast-enhanced imaging findings of the patient based on the one or more non-contrast medical images using a machine learning based system comprises: simultaneously performing a plurality of medical imaging analysis tasks based on the one or more non-contrast medical images using a multi-task learning system, the plurality of medical imaging analysis tasks comprising the determining the likelihood of contrast-enhanced imaging findings and one or more supplemental tasks.
Illustrative embodiment 17. The non-transitory computer-readable storage medium of any one of illustrative embodiments 15-16, wherein determining a likelihood of contrast-enhanced imaging findings of the patient based on the one or more non-contrast medical images using a machine learning based system comprises: segmenting one or more anatomical objects from the one or more non-contrast medical images using a machine learning based segmentation network; extracting features from the one or more non-contrast medical images based on results of the segmentation; and determining the likelihood of contrast-enhanced imaging findings based on the extracted features using a machine learning based classification network.
Illustrative embodiment 18. The non-transitory computer-readable storage medium of illustrative embodiment 17, wherein the features comprise at least one of features characterizing volume and geometry of the one or more anatomical objects, feature characterizing deformation of the one or more anatomical objects, quantitative statistics or texture features of the one or more anatomical objects, latent features extracted by a machine learning based feature extractor network, or radiomic features.
Illustrative embodiment 19. The non-transitory computer-readable storage medium of any one of illustrative embodiments 17-18, the operations further comprising supplementing the extracted features with clinical parameters, wherein determining the likelihood of contrast-enhanced imaging findings based on the extracted features using a machine learning based classification network comprises: determining the likelihood of contrast-enhanced imaging findings based on the supplemented extracted features using the machine learning based classification network.
Illustrative embodiment 20. The non-transitory computer-readable storage medium of any one of illustrative embodiments 15-19, the operations further comprising: acquiring contrast-enhanced medical images of the patient based on the likelihood of contrast-enhanced imaging findings.

1. A computer-implemented method comprising:
receiving one or more non-contrast medical images of a patient;
determining a likelihood of contrast-enhanced imaging findings of the patient based on the one or more non-contrast medical images using a machine learning based system; and
outputting the likelihood of contrast-enhanced imaging findings.

2. The computer-implemented method of claim 1, wherein determining a likelihood of contrast-enhanced imaging findings of the patient based on the one or more non-contrast medical images using a machine learning based system comprises:
simultaneously performing a plurality of medical imaging analysis tasks based on the one or more non-contrast medical images using a multi-task learning system, the plurality of medical imaging analysis tasks comprising the determining the likelihood of contrast-enhanced imaging findings and one or more supplemental tasks.

3. The computer-implemented method of claim 2, wherein the one or more supplemental tasks comprise at least one of segmentation, artifact detection, and disease detection.

4. The computer-implemented method of claim 1, wherein determining a likelihood of contrast-enhanced imaging findings of the patient based on the one or more non-contrast medical images using a machine learning based system comprises:
segmenting one or more anatomical objects from the one or more non-contrast medical images using a machine learning based segmentation network;
extracting features from the one or more non-contrast medical images based on results of the segmentation; and
determining the likelihood of contrast-enhanced imaging findings based on the extracted features using a machine learning based classification network.

5. The computer-implemented method of claim 4, wherein the features comprise at least one of features characterizing volume and geometry of the one or more anatomical objects, feature characterizing deformation of the one or more anatomical objects, quantitative statistics or texture features of the one or more anatomical objects, latent features extracted by a machine learning based feature extractor network, or radiomic features.

6. The computer-implemented method of claim 4, further comprising supplementing the extracted features with clinical parameters, wherein determining the likelihood of contrast-enhanced imaging findings based on the extracted features using a machine learning based classification network comprises:
determining the likelihood of contrast-enhanced imaging findings based on the supplemented extracted features using the machine learning based classification network.

7. The computer-implemented method of claim 1, wherein the receiving, the determining, and the outputting are performed after acquisition of the one or more non-contrast medical images and before acquisition of contrast-enhanced medical images.

8. The computer-implemented method of claim 1, further comprising:
acquiring contrast-enhanced medical images of the patient based on the likelihood of contrast-enhanced imaging findings.

9. The computer-implemented method of claim 1, wherein the one or more non-contrast medical images comprises bSSFP (balanced steady-state free precession) cine images and T1 and T2 mappings.

10. An apparatus comprising:
means for receiving one or more non-contrast medical images of a patient;
means for determining a likelihood of contrast-enhanced imaging findings of the patient based on the one or more non-contrast medical images using a machine learning based system; and
means for outputting the likelihood of contrast-enhanced imaging findings.

11. The apparatus of claim 10, wherein the means for determining a likelihood of contrast-enhanced imaging findings of the patient based on the one or more non-contrast medical images using a machine learning based system comprises:
means for simultaneously performing a plurality of medical imaging analysis tasks based on the one or more non-contrast medical images using a multi-task learning system, the plurality of medical imaging analysis tasks comprising the determining the likelihood of contrast-enhanced imaging findings and one or more supplemental tasks.

12. The apparatus of claim 11, wherein the one or more supplemental tasks comprise at least one of segmentation, artifact detection, and disease detection.

13. The apparatus of claim 10, wherein the means for determining a likelihood of contrast-enhanced imaging findings of the patient based on the one or more non-contrast medical images using a machine learning based system comprises:
means for segmenting one or more anatomical objects from the one or more non-contrast medical images using a machine learning based segmentation network;
means for extracting features from the one or more non-contrast medical images based on results of the segmentation; and
means for determining the likelihood of contrast-enhanced imaging findings based on the extracted features using a machine learning based classification network.

14. The apparatus of claim 10, wherein the means for receiving, the means for determining, and the means for outputting are performed after acquisition of the one or more non-contrast medical images and before acquisition of contrast-enhanced medical images.

15. A non-transitory computer-readable storage medium comprising instructions which, when executed by a computer, cause the computer to carry out operations comprising:
receiving one or more non-contrast medical images of a patient;
determining a likelihood of contrast-enhanced imaging findings of the patient based on the one or more non-contrast medical images using a machine learning based system; and
outputting the likelihood of contrast-enhanced imaging findings.

16. The non-transitory computer-readable storage medium of claim 15, wherein determining a likelihood of contrast-enhanced imaging findings of the patient based on the one or more non-contrast medical images using a machine learning based system comprises:
simultaneously performing a plurality of medical imaging analysis tasks based on the one or more non-contrast medical images using a multi-task learning system, the plurality of medical imaging analysis tasks comprising the determining the likelihood of contrast-enhanced imaging findings and one or more supplemental tasks.

17. The non-transitory computer-readable storage medium of claim 15, wherein determining a likelihood of contrast-enhanced imaging findings of the patient based on the one or more non-contrast medical images using a machine learning based system comprises:
segmenting one or more anatomical objects from the one or more non-contrast medical images using a machine learning based segmentation network;
extracting features from the one or more non-contrast medical images based on results of the segmentation; and
determining the likelihood of contrast-enhanced imaging findings based on the extracted features using a machine learning based classification network.

18. The non-transitory computer-readable storage medium of claim 17, wherein the features comprise at least one of features characterizing volume and geometry of the one or more anatomical objects, feature characterizing deformation of the one or more anatomical objects, quantitative statistics or texture features of the one or more anatomical objects, latent features extracted by a machine learning based feature extractor network, or radiomic features.

19. The non-transitory computer-readable storage medium of claim 17, the operations further comprising supplementing the extracted features with clinical parameters, wherein determining the likelihood of contrast-enhanced imaging findings based on the extracted features using a machine learning based classification network comprises:
determining the likelihood of contrast-enhanced imaging findings based on the supplemented extracted features using the machine learning based classification network.

20. The non-transitory computer-readable storage medium of claim 15, the operations further comprising:
acquiring contrast-enhanced medical images of the patient based on the likelihood of contrast-enhanced imaging findings.
